(19) United States
(12) Patent Application Publication
(10) Pub. No.: US 2014/0146002 A1
(43) Pub. Date: May 29, 2014

(54) Touch Detection System of Terminal Device and Terminal Device

(71) Applicant: FOCALTECH SYSTEMS, LTD., Grand Cayman (KY)

(72) Inventors: Lianghua MO, Shenzhen (CN); Haijun HU, Shenzhen (CN); Weiping LIU, Shenzhen (CN)

(73) Assignee: FOCALTECH SYSTEMS, LTD., Grand Cayman (KY)

(21) Appl. No.: 13/800,672

(22) Filed: Mar. 13, 2013

(30) Foreign Application Priority Data
Nov. 29, 2012 (CN) 201210502006.X

(51) Int. Cl. G06F 3/044

(52) U.S. Cl. CPC G06F 3/044
USPC 345/174

(57) ABSTRACT

A touch detection system of a terminal device and a terminal device are provided. In the touch detection system, once the charging of the mutual-capacitor and the self-capacitor, the detection circuit can be multiplexed. That is, the capacitor charging/discharging circuit is connected to the amplifier, the charge in the self-capacitor or the mutual-capacitor is transferred to the output of the amplifier by the capacitor between the output and one input of the amplifier, and the other input of the amplifier is connected to a reference signal source, so that a signal processing unit can determine a touch on the capacitive touch screen based on the output voltage of the amplifier. It is unnecessary to use multiple circuits to detect the capacitances of the mutual-capacitor and the self-capacitor, so as to simplify the structure for detecting the touch of the customer on the capacitive touch screen in the terminal device.

This application claims the priority of Chinese Patent Application No. 201210502006.X, entitled “TOUCH DETECTION SYSTEM OF TERMINAL DEVICE AND TERMINAL DEVICE”, filed with the Chinese Patent Office on Nov. 29, 2012, which is incorporated by reference in its entirety herein.

### FIELD OF THE INVENTION

The invention relates to the technical field of electronic equipment, and in particular to a touch detection system of a terminal device and a terminal device.

### BACKGROUND OF THE INVENTION

An existing terminal device with a capacitive touch screen includes a capacitive touch screen and a touch detection circuit. The capacitive touch screen includes: a touch housing that is provided outside the terminal device to be exposed and is visible by the customer; and an inductive electrode adapted to detect a touch of the customer on the capacitive touch screen. A self-capacitor is formed between the inductive electrode and a system ground of the terminal device, and a mutual-capacitor is formed between inductive electrodes with different polarities. In this way, when the customer touches the touch housing, the capacitances of the self-capacitor and mutual-capacitor of the inductive electrode provided under the touch housing will be varied, and the touch detection circuit determines the touch of the customer on the capacitive touch screen of the terminal device by detecting the variance in the capacitance of the self-capacitor and/or the mutual-capacitor of the inductive electrode. However, in the prior art, different touch detection circuits are used to detect the capacitance of the self-capacitor and the mutual-capacitor, which will occupy a certain space of the terminal device and cause a complicated structure.

### SUMMARY OF THE INVENTION

A touch detection system of a terminal device and a terminal device are provided according to an embodiment of the invention, for simplifying the structure for detecting the touch of the customer on the capacitive touch screen in the terminal device.

A touch detection system of a terminal device is provided according an embodiment of the invention, which is applied in a terminal device with a capacitive touch screen, where the capacitive touch screen includes a plurality of pairs of inductive electrodes and a touch housing, and the touch detection system includes a capacitor charging/discharging circuit, an amplifier, a signal processing unit and a control circuit;

the capacitor charging/discharging circuit includes a first electrode connecting end and a second electrode connecting end which are connected to one pair of the plurality of pairs of inductive electrodes, and is adapted to charge and discharge a self-capacitor and a mutual-capacitor of the inductive electrode;

the first electrode connecting end of the capacitor charging/discharging circuit is connected to a first input of the amplifier which is connected with an output of the amplifier via a capacitor, and a second input of the amplifier is connected to a reference signal source;

the output of the amplifier is connected to the signal processing unit, and the signal processing unit is adapted to determine a touch on the capacitive touch screen according to a signal output from the output of the amplifier; and

the control circuit is adapted to control the capacitor charging/discharging circuit to charge and discharge the self-capacitor and/or the mutual-capacitor of the inductive electrode.

A terminal device is provided according to an embodiment of the invention, which includes a capacitive touch screen and a touch detection system, the capacitive touch screen includes a plurality of pairs of inductive electrodes and a touch housing, one pair of the plurality of pairs of inductive electrodes are respectively connected to two electrode connecting ends of the touch detection system, where

the touch detection system includes a capacitor charging/discharging circuit, an amplifier, a signal processing unit and a control circuit;

the capacitor charging/discharging circuit includes a first electrode connecting end and a second electrode connecting end which are connected to one pair of the plurality of pairs of inductive electrodes, and is adapted to charge and discharge a self-capacitor and a mutual-capacitor of the inductive electrode;

the first electrode connecting end of the capacitor charging/discharging circuit is connected to a first input of the amplifier which is connected to an output of the amplifier via a capacitor, and a second input of the amplifier is connected to a reference signal source;

the output of the amplifier is connected to the signal processing unit, and the signal processing unit is adapted to determine a touch on the capacitive touch screen according to a signal output from the output of the amplifier; and

the control circuit is adapted to control the capacitor charging/discharging circuit to charge and discharge the self-capacitor and/or the mutual-capacitor of the inductive electrode.

In the touch detection system provided according to the embodiment of the invention, the inductive electrodes provided under the touch housing of the terminal device can be connected to the electrode connecting ends of the capacitor charging/discharging circuit, so as to charge and discharge the self-capacitor and the mutual-capacitor of the connected inductive electrodes. The capacitor charging/discharging circuit is connected to the amplifier, the charge in the self-capacitor or the mutual-capacitor is transferred to the output of the amplifier by a capacitance between a output and one input of the amplifier, and an other input of the amplifier is connected to a reference signal source, so that the signal processing unit can effectively determine the touch on the capacitive touch screen of the terminal device based on the voltage output from the output of the amplifier. In the system, the control circuit is adapted to control the capacitor charging/discharging circuit to charge and discharge the self-capacitor or the mutual-capacitor of the inductive electrode. In the system, after the mutual-capacitor and the self-capacitor are charged by the capacitor charging/discharging circuit, the detection circuit for detecting the capacitance of the mutual-capacitor can also be used to detect the capacitance of the self-capacitor. In this way, during the touch detection, it is unnecessary to use different circuits to detect the capacitances of the mutual-capacitor and the self-capacitor, and thus the structure for detecting the touch of the customer on the capacitive touch screen in the terminal device is simplified. Meanwhile, in the case that different circuits are used to detect the capacitances of the mutual-capacitor and the self-capacitor, the detections of the capacitances of the mutual-capacitor and the self-capacitor will be influenced by a charge sharing which is occurred between two different circuits. However, this influence can be avoided and the sensitivity of the detection can be improved by using the touch detection system according to the embodiment of the invention.

### BRIEF DESCRIPTION OF THE DRAWINGS

In order to illustrate the technical solutions according to the embodiments of the present invention or in the prior art more clearly, drawings to be used in the description of the prior art or the embodiments will be described briefly hereinafter. Apparently, the drawings described hereinafter are only some embodiments of the present invention, and other drawings may be obtained by those skilled in the art according to those drawings without creative work.

FIG. 1 is a schematic structural diagram of a capacitive touch screen in a terminal device according to an embodiment of the invention;

FIG. 2 is a schematic structural diagram of a touch detection system of a terminal device according to an embodiment of the invention;

FIG. 3 is a schematic structural diagram of a touch detection system of another terminal device according to an embodiment of the invention;

FIG. 4 is a schematic structural diagram of a filter circuit in a touch detection system according to an embodiment of the invention;

FIG. 5 is a schematic structural diagram of a touch detection system of yet another terminal device according to an embodiment of the invention;

FIG. 6 is a schematic diagram of a control performed by a control circuit in a touch detection system according to an embodiment of the invention; and

FIG. 7 is a schematic structural diagram of a terminal device according to an embodiment of the invention.

### DETAILED DESCRIPTION OF THE INVENTION

Hereinafter, the technical solution in the embodiment of the present invention will be described clearly and completely in conjunction with the drawings in the embodiment of the present invention. Obviously, the described embodiments are only a part of the embodiments of the present invention, but not all the embodiments. All the other embodiments obtained by those skilled in the art based on the embodiment in the present invention without invention efforts will fall within the scope of protection of the present invention.

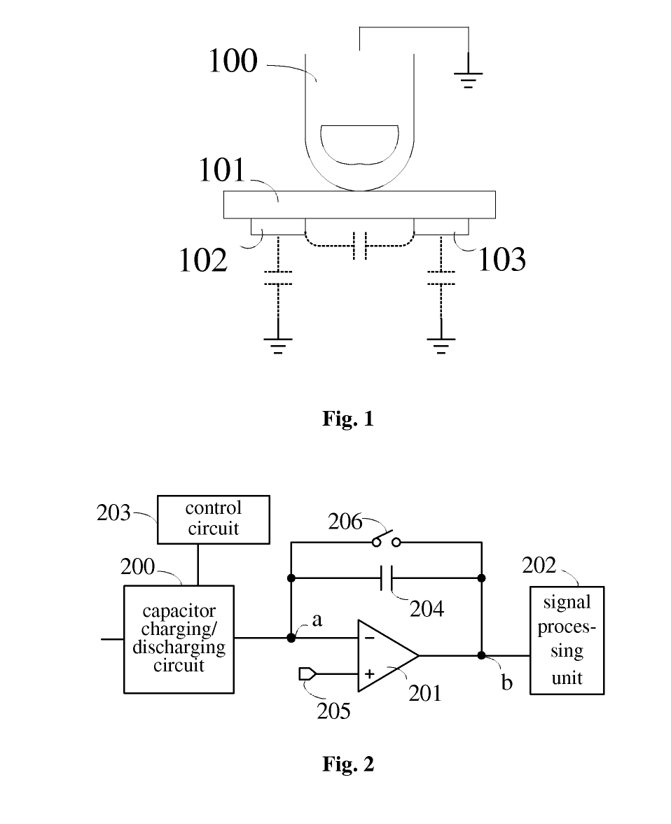

A touch detection system is provided according to an embodiment of the invention, which is mainly applied for a terminal device with a capacitive touch screen. The terminal device includes a capacitive touch screen as shown in FIG. 1. The capacitive touch screen can include a touch housing 101 and multiple pairs of inductive electrodes 102 and 103, and both electrodes in each pair of inductive electrodes have opposite polarities and can form a mutual-capacitor. Under the touch housing 101, the multiple inductive electrodes 102 are provided in an X direction, and the multiple inductive electrodes 103 are provided in a Y direction.

A mutual-capacitor is formed between one of the inductive electrodes 102 and another inductive electrode 103 that is located nearby the inductive electrode 102 and has opposite polarity to that of the inductive electrodes 102 (the capacitor drawn in the dashed line in FIG. 1 indicates that the capacitor is not an actual one, but is formed due to the locations of the actual means). Self-capacitors are formed respectively between the inductive electrodes 102 and a system ground of the terminal device or between the inductive electrodes 103 and the system ground. Thus, when the touch housing 101 is touched by a touch body 100 (which can be a finger, a touch pen or the like), because the touch body 101 is also connected to the ground, capacitors are formed respectively between the inductive electrodes 102 and 103 provided under the touch housing 101 and the ground connected to the touch body 100, so that the capacitances of the self-capacitors of the inductive electrodes 102 and 103 are varied. The capacitance of the self-capacitor can be detected by the touch detection system according to the embodiment of the invention, so as to determine the touch on the capacitive touch screen. Meanwhile, when the touch housing 101 is touched by the touch body 100, the capacitance between the touch body 100 and the ground can absorb a part of the power lines of the electric field between the inductive electrodes 102 and 103, so as to reduce the capacitance of the mutual-capacitor between the inductive electrodes 102 and 103. The capacitance of the mutual-capacitor can also be detected by the touch detection system according to the embodiment of the invention, so as to determine the touch on the capacitive touch screen.

Referring to FIG. 2, the touch detection system according to the embodiment of the invention can include: a capacitor charging/discharging circuit 200, an amplifier 201, a signal processing unit 202 and a control circuit 203.

The capacitor charging/discharging circuit 200 includes electrode connecting ends connected to the inductive electrodes, and adapted to charge and discharge a self-capacitor and a mutual-capacitor of the inductive electrode.

One of the electrode connecting ends of the capacitor charging/discharging circuit 200 is (directly or indirectly) connected to an input a of the amplifier 201 which is connected to an output b of the amplifier 201 via a capacitor 204, and the other input of the amplifier 201 is connected to a reference signal source 205.

It can be understood that the above capacitor charging/discharging circuit 200 can include a self-capacitor charging/discharging circuit and a mutual-capacitor charging/discharging circuit. In the self-capacitor charging/discharging circuit, a first input signal source is connected to the electrode connecting end, and thus the first input signal source can charge the self-capacitor formed between the inductive electrode 102 (or 103) connected to the electrode connecting end and the system ground of the terminal device. In the mutual-capacitor charging/discharging circuit, a second input signal source is connected to one of the electrode connecting ends, and thus the polarity of the inductive electrode 102 (or 103) connected to the one of the electrode connecting ends is opposed to that of the inductive electrode 103 (or 102) connected to the electrode connecting end of the amplifier 201 in the capacitor charging/discharging circuit 200, so as to form a mutual-capacitor between the inductive electrode 102 (or 103) and the inductive electrode 103 (or 102). In this case, the mutual-capacitor formed between the inductive electrodes 102 and 103 can be charged by the second input signal source.

The amplifier 201 is adapted to reduce the voltage of the one input a of the amplifier 201 to be equal to or approximately equal to the voltage of the reference signal source 205 during the discharging of the self-capacitor or the mutual-capacitor. Further, due to the capacitor 204 connected between the output and input a of the amplifier 201, the variance in the charge of the input a can be transferred to the output of the amplifier 201 during the charging and discharging of the capacitor 204, so that the voltage output from the amplifier 201 varies based on the voltage of the reference signal source 205, and the voltage can be amplified. In this way, the signal processing unit 202 can perform the corresponding process effectively according to the signal output from the output of the amplifier 201, but will not be unable to perform any process because the signal transferred to the signal processing unit 201 is too weak. The above reference signal source 205 is a DC voltage signal source.

The output of the amplifier 201 is connected to the signal processing unit 202, and the signal processing unit 202 determines the touch on the capacitive touch screen in the above terminal device based on the signal output from the output of the amplifier 201. Because the capacitances of the self-capacitor and mutual-capacitor of the inductive electrode connected to the electrode connecting end of the capacitor charging/discharging circuit 200 will be varied with the touch of the touch body 100 on the capacitive touch screen, the amount of the charge transferred to the output of the amplifier 201 in the case of touch and un-touch are different. Specifically, in a period of time, the variance in the voltage output from the amplifier 201 when the capacitive touch screen is un-touched is different from that when the capacitive touch screen is touched. Therefore, the variance in the voltage output from the output of the amplifier 201 in a period of time can be detected by the signal processing unit 202. If the variance in the voltage is within a preset range, it indicates that the capacitive touch screen of the terminal device is touched by a touch body 100; and the position at which the capacitive touch screen is touched by the touch body 100 can be determined based on the position of the inductive electrode under the touch housing 101, where the inductive electrode corresponds to the mutual-capacitor or self-capacitor with the varied capacitance.

Further, before determining the touch on the capacitive touch screen in the above terminal device, the signal processing unit 202 can perform filtering and perform analog-to-digital conversion on the signal output from the amplifier 201 to obtain a digital signal, and then determine the touch on the capacitive touch screen according to the digital signal.

The control circuit 203 is adapted to control the capacitor charging/discharging circuit 200 to charge and discharge the self-capacitor and/or the mutual-capacitor of the inductive electrode. For example, when the self-capacitor of the inductive electrode 102 (or 103) connected to the capacitor charging/discharging circuit 200 is charged, the mutual-capacitor connected to this inductive electrode is not charged according to the control of the control circuit 203. Alternatively, the self-capacitor and the mutual-capacitor of the inductive electrode are charged by the capacitor charging/discharging circuit 200 at the same time according to the control of the control circuit 203.

It can be understood that after the self-capacitor and/or the mutual-capacitor is charged by the above capacitor charging/discharging circuit 200, the control circuit 203 can control the capacitor charging/discharging circuit 200 to discharge the self-capacitor and/or the mutual-capacitor. Further, in order to facilitate the control circuit 203 to control the discharging, a discharging selection circuit (not shown in the Figure) can be connected between one of the electrode connecting ends of the capacitor charging/discharging circuit 200 and one of the inputs of the amplifier 201. Thus, the control circuit 203 can control this discharging selection circuit to select the capacitor charging/discharging circuit 200 to discharge the self-capacitor or the mutual-capacitor formed by the inductive electrode. In the specific implementation, the discharging selection circuit can be implemented by a switch connected in the circuit. The control circuit 203 can control the discharging selection circuit to perform the selection in a time-division manner. For example, the control circuit 203 can control the discharging selection circuit to select the capacitor charging/discharging circuit 200 to discharge the self-capacitor during a period of time and to discharge the mutual-capacitor during another period of time.

Further, in the specific implementation, a switch 206 can be connected in parallel to the capacitor 204. In this case, the control circuit 203 further needs to be connected to the control end of the switch 206, so as to reset the capacitor 204, that is, charge and zero the capacitor 204, after the switch 206 is switched on. During the charge transferring due to the discharge of the self-capacitor or mutual-capacitor of the inductive electrode connected to the capacitor charging/discharging circuit 200, the control circuit 203 can control the switch 206 to switch off, so that a charge transferring circuit is formed by the amplifier 201 and the capacitor 204.

It is to be noted that in the above touch detection system, the structure from the capacitor charging/discharging circuit 200 to the output of the amplifier 201 is only explained with respect to a pair of inductive electrodes 102 and 103 that form the mutual-capacitor and are provided under the touch housing 101 of the terminal device. In practice, multiple pairs of inductive electrodes need to be provided under the touch housing 101, and the above structure from the capacitor charging/discharging circuit 200 to the output of the amplifier 210 can be connected to each pair of inductive electrodes. To simplify the structure of the terminal device, one capacitor charging/discharging circuit 200 can be connected with multiple pairs of inductive electrodes. That is to say, a capacitor charging/discharging circuit 200 can include a charging/discharging circuit for self-capacitors and mutual-capacitors of multiple pairs of inductive electrodes. The control circuit 203 controls the capacitor charging/discharging circuit 200 to charge the self-capacitors or the mutual capacitors of different inductive electrodes in the time-division manner, and then the charge from the self-capacitor or the mutual capacitor is transferred by the amplifier 201 and the capacitor 204. Finally, the signal processing unit 202 detects the touch which presses the touch housing 101 and corresponds to respective electrodes. In this way, the above structure from the capacitor charging/discharging circuit 200 to the amplifier 201 can be used for the multiple pairs of inductive electrodes.

It can be seen that in the touch detection system according to the embodiment of the invention, the inductive electrodes provided under the touch housing in the terminal device can be connected via the electrode connecting ends of the capacitor charging/discharging circuit, so as to charge and discharge the self-capacitor and mutual-capacitor of the connected inductive electrodes. The capacitor charging/discharging circuit is connected to an amplifier, the charge in the self-capacitor or the mutual-capacitor is transferred to an output of the amplifier by a capacitor between the output and an input of the amplifier, and the other input of the amplifier is connected to a reference signal source, so that the signal processing unit can effectively determine the touch on the capacitive touch screen of the terminal device based on the voltage output from the output of the amplifier. In the system, the control circuit controls the capacitor charging/discharging circuit to charge and discharge the self-capacitor or the mutual-capacitor of the inductive electrode. In the system, the mutual-capacitor and the self-capacitor are charged by the capacitor charging/discharging circuit respectively, and the detection circuit for detecting the capacitances of the mutual-capacitor and the self-capacitor can be multiplexed, so that it is unnecessary to use different circuits to detect the capacitances of the mutual-capacitor and the self-capacitor during the touch detection. Thus, the structure for detecting the touch of the customer on the capacitive touch screen in the terminal device is simplified. Meanwhile, in the case that different circuits are used to detect the capacitances of the mutual-capacitor and the self-capacitor, the detections of the capacitances of the mutual-capacitor and self-capacitor will be influenced by a charge sharing which is occurred between two different circuits. However, this influence can be avoided and the sensitivity of the detection can be improved by using the touch detection system according to the embodiment of the invention.

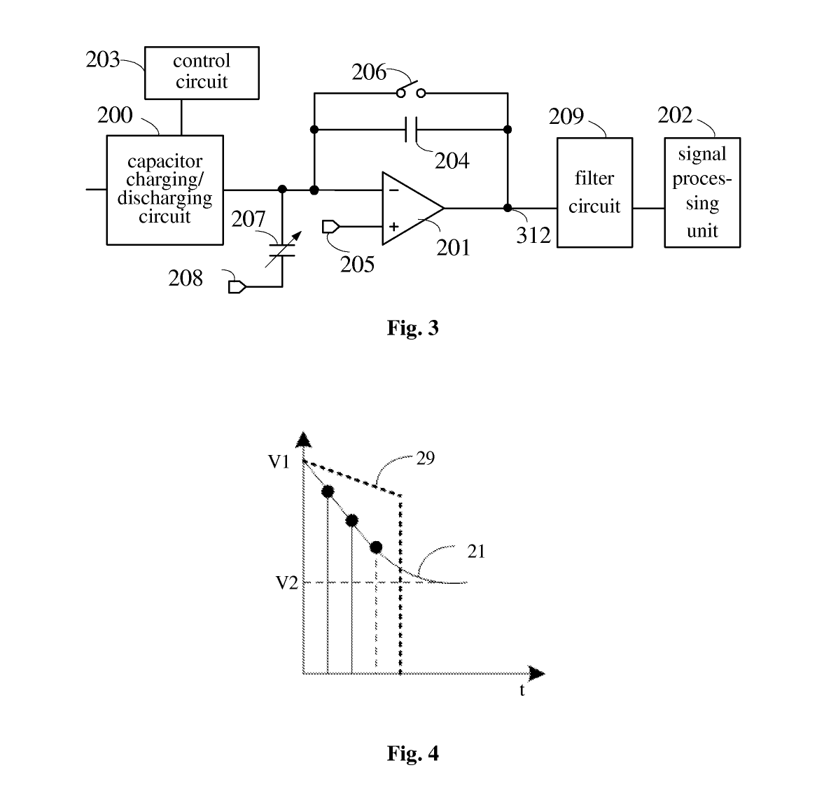

Referring to FIG. 3, in a specific embodiment, in addition to the structure as shown in FIG. 2, the touch detection system can further include a charge-sharing capacitor 207 and a filter circuit 209.

An end of the charge-sharing capacitor 207 is connected to an input of the amplifier 201, that is, the input connected to the electrode connecting end of the capacitor charging/discharging circuit 200, and the other end of the charge-sharing capacitor 207 is connected to the reference signal source 208. The control circuit 203 needs to control the switch between higher and lower voltages of the reference signal source 208. Specifically, when the mutual-capacitor or the self-capacitor starts to be discharged, the control circuit 203 can control the reference signal source 208 to switch from the higher voltage to the lower voltage, so that a part of the charge of the self-capacitor or the mutual-capacitor can be shared by the charge-sharing capacitor 207. In this way, the amount of the charge transferred to the output of the amplifier 201 is reduced, the variance in the voltage at the output of the amplifier 201 can be controlled within a certain range by the charge-sharing capacitor 207, and the signal processing unit 202 can determine the touch on the capacitive touch screen more effectively.

In the system, the amplifier 201 is connected to the signal processing unit 202 via the filter circuit 209 which can filter the signal output from the amplifier 201. The signal 21 output from the amplifier 201 has a waveform as shown in FIG. 4. At the beginning, the amplitude V1 of the signal is larger, and the amplitude V2 reduces gradually in the following. Assuming that the amplitude of the interference in the period is constant, the latter sampling point has a poor signal-to-noise ratio than the former. The filter signal 29 of the filter circuit 209 has higher gain with respect to the former sampling point and lower gain with respect to the latter sampling point, so as to ensure the signal-to-noise ratio of multiple samplings. During the filtering, the filter circuit 209 can be implemented by a filtering method such as a Gaussian window or a Tukey window, which will not be described in detail here.

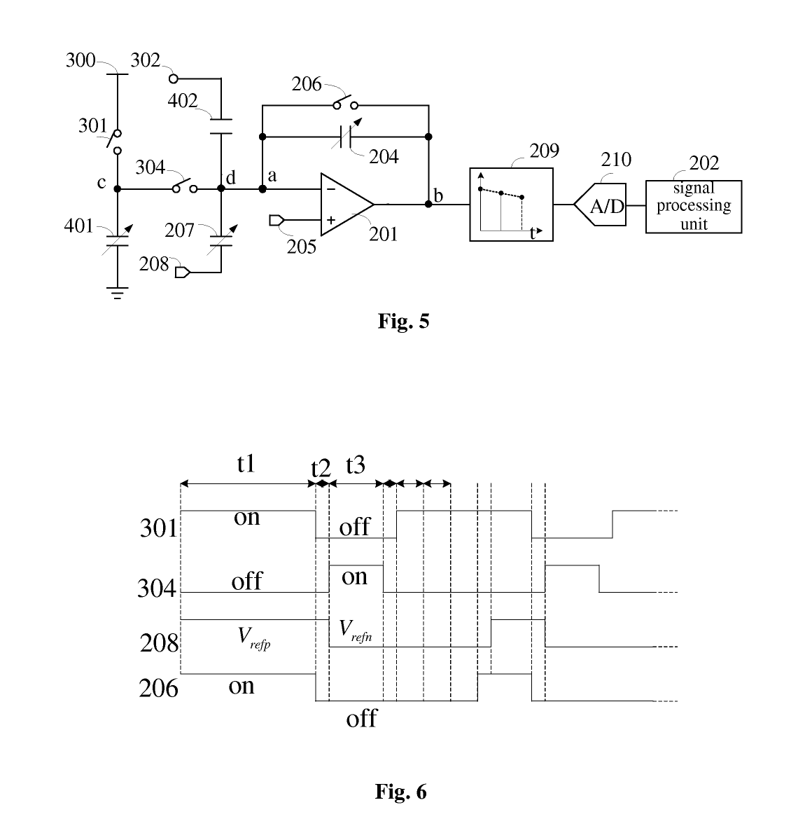

Hereinafter, the touch detection system according to the embodiment of the invention will be explained by a specific embodiment. Referring to FIG. 5, the capacitor charging/discharging circuit in the touch detection system includes electrode connecting ends c and d; a self-capacitor charging/discharging circuit which includes a first input signal source 300 and a switch 301, where the first input signal source 300 is connected to the electrode connecting end c via the switch 301, the electrode connecting end c is used to connect the inductive electrode 102, and the self-capacitor charging/discharging circuit is adapted to charge and discharge the self-capacitor 401 formed between the inductive electrode 102 and the system ground of the terminal device; and a mutual-capacitor charging/discharging circuit which mainly includes a second input signal source 302 connected to the electrode connecting end c. The other electrode connecting end d is connected to an input a of the amplifier 201, the electrode connecting end d is used to connect the inductive electrode 103, and the mutual-capacitor charging/discharging circuit is adapted to charge and discharge the mutual-capacitor 402 formed between the inductive electrodes 102 and 103.

In the system, a discharging selection circuit is connected between the electrode connecting end c of the capacitor charging/discharging circuit and the input a of the amplifier 201. The discharging selection circuit includes a switch 304 for selecting the self-capacitor 401 or the mutual-capacitor 402 to perform the discharge; and in the system. In addition, the method further includes an analog-to-digital (A/D) converter 210 between the filter circuit 209 and the signal processing unit 202, for converting the analog signal output from the filter circuit 209 into a digital signal. Other structures in the system are the same as those described in the above embodiment, which will not be described in detail here. The control circuit (not shown in FIG. 5) in the system can control the switch 301, the switch 304 and the switch 206 to switch on or off, and can control the first and second input signal sources 300 and 302, and the reference signal sources 208 and 205. Under the control of the control circuit, the system can detect the capacitance of the mutual-capacitor 402 and the self-capacitor 401, so as to determine the touch of the touch body 100 on the capacitive touch screen of the terminal device.

Specifically, (1) in the case that the second input signal source 302 does not provide a signal source according to the control of the control circuit, the system enters into the mode for detecting the capacitance of the self-capacitor.

In the mode for detecting the capacitance of the self-capacitor, the control circuit can perform the control in accordance with the schematic diagram as shown in FIG. 6. In the period t1, according to the control of the control circuit, the switch 304 switches off, the switch 301 switches on and the switch 206 switches on, and the reference signal source 208 is provided as a high voltage V_{refp}, and the first input signal source 300 provides the signal source. In this case, the self-capacitor 401 is charged by the first input signal source 300, the capacitor 204 is reset, and thus the charge Qₜ=V_{ddh}·Cₜ is stored on the self-capacitor 401, where V_{ddh} is a voltage of the first input signal source 300, and Cₜ is a capacitance of the self-capacitor 401.

In the period t2, according to the control of the control circuit, the switch 301 switches from off to on, the switch 304 switches from off to on and the switch 206 switches from on to off. The reference signal source 208 changes from the high voltage V_{refp} to a low voltage V_{refn}. Then, in the following period t3, the self-capacitor 401 is discharged, and the variance in the charge on the self-capacitor 401 is ΔQₜ=(V_{ddh}−V_{ref})·Cₜ, where V_{ref} is a voltage of the reference signal source 205. A part of the charge on the self-capacitor 401 is transferred onto the charge-sharing capacitor 207, and another part of the charge on the self-capacitor 401 is transferred to the output b of the amplifier 201 via the input a of the amplifier 201 and the capacitor 204. Thus, the variance in the charge on the charge-sharing capacitor 207 is ΔQ_{b}=(V_{refp}−V_{refn})·C_{b}, where C_{b} is a capacitance of the charge-sharing capacitor 207; and the variance in the charge on the capacitor 204 is ΔQ_{f}=ΔQₜ−ΔQ_{b}=(V_{ddh}−V_{ref})·Cₜ−(V_{refp}−V_{fefn})·C_{b}. The final variance in the voltage at the output b of the amplifier 201 is

$$Δ {V}_{out} = ( {V}_{ddh} - {V}_{ref} ) \cdot \frac{{C}_{t}}{{C}_{f}} - ( {V}_{refp} - {V}_{refn} ) \cdot \frac{{C}_{b}}{{C}_{f}} ,$$

where C_{f} is a capacitance of the capacitor 204.

When the touch housing 101 of the capacitive touch screen is touched by the touch body 100, the capacitance of the self-capacitor 401 of the inductive electrode 102 provided under a touch point of the touch housing 101 is varied, in which a capacitance of the self-capacitor 401 is indicated by C_{ty}. In the case that the touch point of the touch housing 101 is not touched by the touch body 100, a capacitance of the self-capacitor 401 of the inductive electrode 102 is indicated by Ctn. Then when the capacitive touch screen is not touched by the touch body 100, the variance in the voltage at the output b of the amplifier 201 is

$$Δ {V}_{outn} = ( {V}_{ddh} - {V}_{ref} ) \cdot \frac{{C}_{tn}}{{C}_{f}} - ( {V}_{refp} - {V}_{refn} ) \cdot \frac{{C}_{b}}{{C}_{f}}$$

(referred to as “raw data”); and when the capacitive touch screen is touched by the touch body 100, the variance in the voltage at the output b of the amplifier 201 is

$$Δ {V}_{outy} = ( {V}_{ddh} - {V}_{ref} ) \cdot \frac{{C}_{ty}}{{C}_{f}} - ( {V}_{refp} - {V}_{refn} ) \cdot \frac{{C}_{b}}{{C}_{f}} .$$

Thus, when the signal processing unit 202 detects that the variance of the voltage is in a certain range (nearby ΔV_{outy}), it indicates that the capacitive touch screen of the terminal device is touched by the touch body 100. The difference (referred to as “differ” value) between the variances in the voltages at the output b in the case of touch and in the case of un-touch is

$${V}_{differ} = ( {V}_{ddh} - {V}_{ref} ) \cdot \frac{{C}_{ty} - {C}_{tn}}{{C}_{f}} ;$$

the greater the “differ” value, the greater the variance of the self-capacitor 401 in the two cases, and the more accurate the detection of the touch.

To increase the “differ” value, one way is to increase the voltage Vddh of the first input signal source 300. In this case, the high-voltage process needs to be performed, which will increase the cost of the chip. Another way is to decrease the capacitance of the capacitor 204, and the area of the chip can be decreased at the same time. However, the capability of anti-noise will be reduced and the output of the amplifier 201 is easily saturated. Thus the above two ways need to be considered synthetically. However, no matter which way is adopted, the value of the “raw data” will be increased when the “differ” value is increased. The value of the “raw data” can be reduced by the method in which a part of the charge is shared by the charge-sharing capacitor 207. Finally, the values of the “differ” and the “raw data” can be controlled within a reasonable range.

(2) In the case that the first input signal source 300 does not provide a signal source, the second input signal source 302 provides a signal source, and the switch 304 switches off according to the control of the control circuit, the system enters into the mode for detecting the capacitance of the mutual-capacitor. The process for detecting the capacitance of the mutual capacitor 402 is similar to the process for detecting the capacitance of the self-capacitor 401, which will be omitted herein.

In conclusion, in the touch detection system according to the embodiments of the invention, since the circuits for detecting the capacitance of the self-capacitor and the mutual-capacitor are multiplexed, the structure for detecting the touch on the capacitive touch screen in the terminal device is simplified.

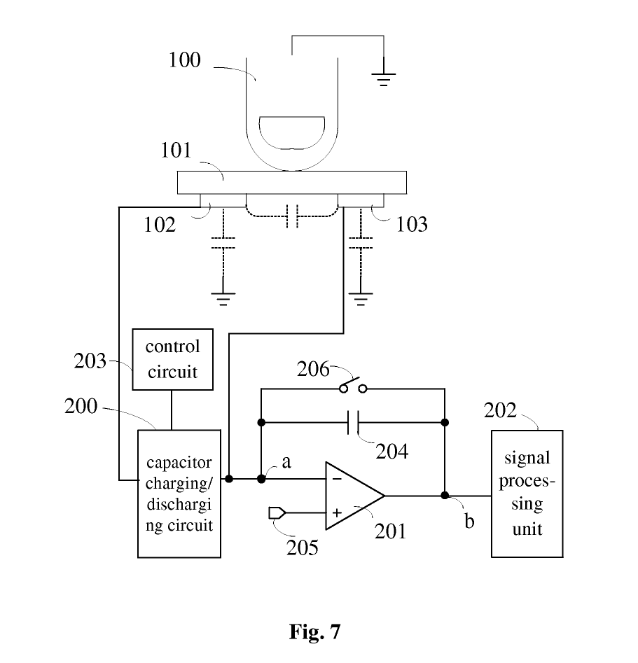

A terminal device is further provided according to an embodiment of the invention, which has a structure as shown in FIG. 7. The terminal device includes a capacitive touch screen and a touch detection system. The capacitive touch screen includes multiple pairs of inductive electrodes and a touch housing 101, where one pair of the multiple pairs of inductive electrodes 101 and 102 have different polarities to form a mutual-capacitor and are respectively connected to two electrode connecting ends of the touch detection system. The touch detection system has a structure which is the same as that of the touch detection system described in the above embodiment, which will be omitted herein.

A touch detection system of a terminal device and a terminal device have been described in detail above according to the embodiment of the invention. Specific examples are used to explain the principle and the embodiment of the invention herein, the explanation of the above embodiments is only for understanding the method of the invention and the core idea thereof; and meanwhile, variations can be made to the specific embodiment and the application scope by those skilled in the art in accordance with the idea of the invention. In conclusion, the content of the specification should not be interpreted as to limit the invention.

1. A touch detection system of a terminal device, which is applied in a terminal device with a capacitive touch screen, the capacitive touch screen comprising a plurality of pairs of inductive electrodes and a touch housing, the touch detection system comprising a capacitor charging/discharging circuit, an amplifier, a signal processing unit and a control circuit, wherein
the capacitor charging/discharging circuit comprises a first electrode connecting end and a second electrode connecting end which are connected to one pair of the plurality of pairs of inductive electrodes, and is adapted to charge and discharge a self-capacitor and a mutual-capacitor of the inductive electrode;
the first electrode connecting end of the capacitor charging/discharging circuit is connected to a first input of the amplifier which is connected with an output of the amplifier via a capacitor, and a second input of the amplifier is connected to a reference signal source;
the output of the amplifier is connected to the signal processing unit, and the signal processing unit is adapted to determine a touch on the capacitive touch screen according to a signal output from the output of the amplifier; and
the control circuit is adapted to control the capacitor charging/discharging circuit to charge and discharge the self-capacitor and/or the mutual-capacitor of the inductive electrode.

2. The touch detection system according to claim 1, further comprising a charge-sharing capacitor, wherein an end of the charging-sharing capacitor is connected to the first input of the amplifier, and the other end of the charging-sharing capacitor is connected to the reference signal source, and wherein
the control circuit is further adapted to control the reference signal source to switch between a high voltage and a low voltage.

3. The touch detection system according to claim 1, wherein the capacitor charging/discharging circuit comprises a self-capacitor charging/discharging circuit and a mutual-capacitor charging/discharging circuit;
the self-capacitor charging/discharging circuit comprises a first input signal source connected to the first electrode connecting end or the second electrode connecting end; and
the mutual-capacitor charging/discharging circuit comprises a second input signal source connected to the first electrode connecting end, wherein the polarity of the inductive electrode connected to the second electrode connecting end is opposite to that of the inductive electrode connected to the first electrode connecting end.

4. The touch detection system according to claim 1, further comprising a discharging selection circuit, wherein
the first electrode connecting end of the capacitor charging/discharging circuit is connected to the first input of the amplifier via the discharging selection circuit; and
the control circuit is further adapted to control the discharging selection circuit to select the capacitor charging/discharging circuit to discharge the self-capacitor or the mutual-capacitor of the inductive electrode.

5. The touch detection system according to claim 1, further comprising a filter circuit, wherein the output of the amplifier is connected to the signal processing unit via the filter circuit, and
the filter circuit is adapted to filter a signal output from the amplifier.

6. A terminal device, comprising a capacitive touch screen and a touch detection system, wherein the capacitive touch screen comprises a plurality of pairs of inductive electrodes and a touch housing, and the touch detection system comprises a capacitor charging/discharging circuit, an amplifier, a signal processing unit and a control circuit, and wherein
the capacitor charging/discharging circuit comprises a first electrode connecting end and a second electrode connecting end which are connected to one pair of the plurality of pairs of inductive electrodes, and is adapted to charge and discharge a self-capacitor and a mutual-capacitor of the inductive electrode;
the first electrode connecting end of the capacitor charging/discharging circuit is connected to a first input of the amplifier which is connected with an output of the amplifier via a capacitor, and a second input of the amplifier is connected to a reference signal source;
the output of the amplifier is connected to the signal processing unit, and the signal processing unit is adapted to determine a touch on the capacitive touch screen according to a signal output from the output of the amplifier; and
the control circuit is adapted to control the capacitor charging/discharging circuit to charge and discharge the self-capacitor and/or the mutual-capacitor of the inductive electrode.
